(19) United States
(12) Patent Application Publication
(10) Pub. No.: US 2020/0393563 A1
(43) Pub. Date: Dec. 17, 2020

(54) THREE-DIMENSIONAL WEATHER DISPLAY SYSTEMS AND METHODS THAT PROVIDE REPLAY OPTIONS

(71) Applicant: HONEYWELL INTERNATIONAL INC., Morris Plains, NJ (US)

(72) Inventors: Anil Kumar Songa, Bangalore (IN); Kalaiarasu Velappan, Bangalore (IN); Jonathan Davis, Phoenix, AZ (US)

(73) Assignee: HONEYWELL INTERNATIONAL INC., Morris Plains, NJ (US)

(21) Appl. No.: 16/439,892

(22) Filed: Jun. 13, 2019

(51) Int. Cl. G01S 13/95; G01S 13/91; G01S 7/04

(52) U.S. Cl. CPC G01S 13/953; G01S 7/04; G01S 13/91

(57) ABSTRACT

Three-dimensional (3D) weather display systems and methods are provided. The system receives real-time 3D weather data from a 3D weather radar system along with other sensor data external or internal and stores the received data in the memory buffer. The system is configured to receive spatial and temporal weather replay requests, and responsive to a weather replay request, extracts time-stamped 3D weather data from the memory buffer to construct a weather data loop that is a function of the weather replay request. The system generates display instructions to render the weather data loop, as a simultaneously and continuously replaying overlay, on the display of the real-time 3D weather data. A display device renders the weather data loop in accordance with the instructions.

### TECHNICAL FIELD

The technical field generally relates to weather display systems, and more particularly relates to three-dimensional weather display systems and methods that provide replay options.

### BACKGROUND

Adverse weather costs the aerospace industry billions of dollars each year through delays, cancellations, diversions, disasters, turbulence and severe storm activity. Turbulence, lightning, hail, and other phenomena, if undetected, can cause a variety of undesirable results, such as discomfort on board and damage to the aircraft, regardless of the size and age of the aircraft. In addition, weather-related delays and cancellations cost airlines millions of dollars and cost countries' economies billions of dollars in lost productivity each year. Therefore, the detection and presentation of weather data is of utmost importance to the technical tasks of flying and operating aircraft.

Generally, the most advanced onboard three-dimensional (3D) weather detection used by air transport, business and military aircraft is performed by a 3D weather radar system. 3D weather radar systems may employ sensors to sense or capture, in real-time, weather data and terrain data within a three-dimensional volume in front of the aircraft; and, an associated 3D weather display system visually depicts or renders the weather data and terrain data on a 3D display unit.

Some onboard 3D weather radar systems may incorporate advances in airborne hazard and weather technology and radio frequency engineering in their generation of the weather data for display. These features can improve a pilot's situational awareness and ability to route around hazards and increase safety over two-dimensional weather radar systems.

However, available onboard 3D weather display systems face some limitations. For example, generally, the displayed 3D weather data does not have a temporal context, and the 3D weather display system generally doesn't provide any options to analyze or review a weather trend. In these scenarios, a pilot or crew must perform a manual analysis of the weather to identify a temporal context or weather trend. An effective manual analysis of a weather trend is labor intensive and requires detailed training and experience and may be put aside for other cognitively demanding tasks being attended to. These limitations can inhibit the pilot's ability to take necessary actions.

Accordingly, technologically improved 3D weather display systems are desirable. The desired system provides selective replay options to display weather trends. The desired 3D weather display system is an improved man-machine interface and provides a functional result of credibly assisting the pilot in performing the technical task of operating the aircraft. The following disclosure provides these technological enhancements, in addition to addressing related issues.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A three-dimensional (3D) weather display system is provided. The 3D weather display system includes: a display device configured to render a horizontal navigation display and a vertical situation display; a memory buffer; a control module for receiving real-time 3D weather data within a predefined volume from a 3D weather radar system, generating display instructions for the display device to render the real-time 3D weather data, and storing the real-time 3D weather data in the memory buffer; the control module receiving a weather replay request prescribed by a user and extracting time-stamped 3D weather data from the memory buffer to construct a weather data loop that is a function of the weather replay request; and the control module generating display instructions to render the weather data loop, as a simultaneously and continuously replaying overlay, on the display of the real-time 3D weather data; and the display device renders the weather data loop and the real-time 3D weather data in accordance with the display instructions.

Also provided is a processor-implemented method for three-dimensional (3D) weather display. The method includes: receiving, from a 3D weather radar system, real-time 3D weather data within a 3D volume; instructing a display device to display the real-time 3D weather data; storing time-stamped 3D weather data into a memory buffer; receiving, from a user input system, a weather replay request; constructing a weather data loop that is a function of the weather replay request, by extracting time-stamped 3D weather data from the memory buffer; and generating display instructions to render the weather data loop, as a simultaneously and continuously replaying overlay, on the display of the real-time 3D weather data; and at a display device, responsive to the display instructions, rendering the weather data loop, as a simultaneously and continuously replaying overlay, on the display of the real-time 3D weather data.

Also provided is an aircraft, including: a three-dimensional (3D) weather radar system for sensing real-time 3D weather data within a 3D volume; a memory buffer communicatively coupled to the 3D weather radar system, for storing the real-time 3D weather data, as time-stamped 3D weather data; and a 3D weather display system communicatively coupled to the 3D weather radar system and the memory buffer, the 3D weather display system including: a display device for displaying the real-time 3D weather data; a user input system; and a processor communicatively coupled to the display device and the user input system, the processor for: receiving, from the 3D weather radar system, the real-time 3D weather data within a 3D volume; instructing the display device to display the real-time 3D weather data; receiving, from the user input system, a weather replay request; constructing a weather data loop that is a function of the weather replay request, by extracting time-stamped 3D weather data from the memory buffer; and generating display instructions to render the weather data loop, as a simultaneously and continuously replaying overlay, on the display of the real-time 3D weather data; and the display device, responsive to the display instructions, renders the weather data loop, as a simultaneously and continuously replaying overlay, on the display of the real-time 3D weather data.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present application will hereinafter be described in conjunction with the following drawing figures, wherein like numerals denote like elements, and:

FIG. 1 is an illustration of an aircraft having a three-dimensional (3D) weather radar system and a 3D weather display system, in accordance with various embodiments;

FIG. 2 is a block diagram of a 3D weather display system, in accordance with various exemplary embodiments;

FIG. 3 depicts a method for 3D weather display, in accordance with various exemplary embodiments;

FIG. 4 is an illustration depicting various spatial extents for selecting a weather replay;

FIG. 5 depicts another method for 3D weather display, in accordance with various exemplary embodiments;

FIG. 6 depicts a conventional cockpit display showing weather data on display; and

FIG. 7 depicts an enhanced cockpit display having an enhanced 3D weather display with weather replay option, in accordance with various exemplary embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. The embodiments described herein are exemplary embodiments provided to enable persons skilled in the art to make or use the invention and not to limit the scope of the invention that is defined by the claims. Furthermore, there is no intention to be bound by any expressed or implied theory presented in the preceding technical field, background, summary, or the following detailed description.

As mentioned, with available onboard 3D weather display systems, the displayed 3D weather data generally does not have a temporal context, and the 3D weather display system generally doesn't provide any options to analyze or review a weather trend. This limitation causes a pilot or crew desiring to analyze or review a weather trend to have to perform a manual analysis that is labor intensive and requires detailed training and experience.

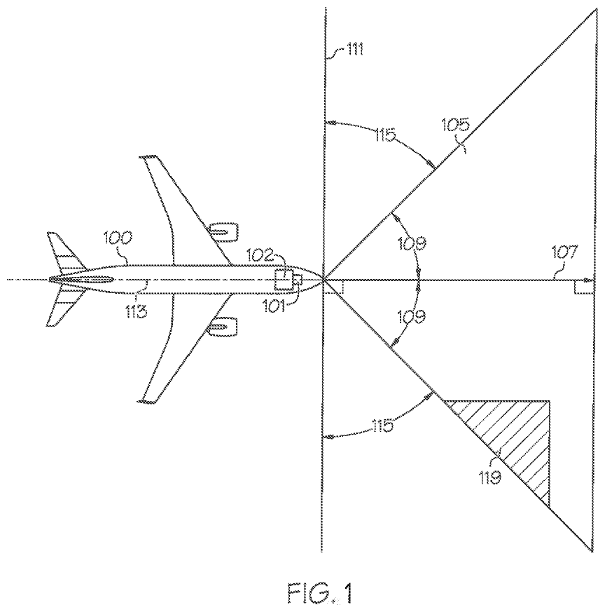

In response to at least these conventional 3D weather display system limitations, an enhanced 3D display system (FIG. 1, 102) is provided. The enhanced 3D weather display system is an objective improvement in the 3D presentation of weather data and credibly assists the pilot in performing the technical task of operating the aircraft.

Turning now to FIG. 1, in an embodiment, the enhanced 3D weather display system 102 (also referred to herein as “system” 102) is generally associated with a mobile platform 100, drone, or vehicle. In various embodiments, and the example described herein, the mobile platform 100 is an aircraft, and is referred to as aircraft 100. Aircraft 100 is shown equipped with a conventionally available onboard 3D weather radar system 101 and the provided 3D weather display system 102.

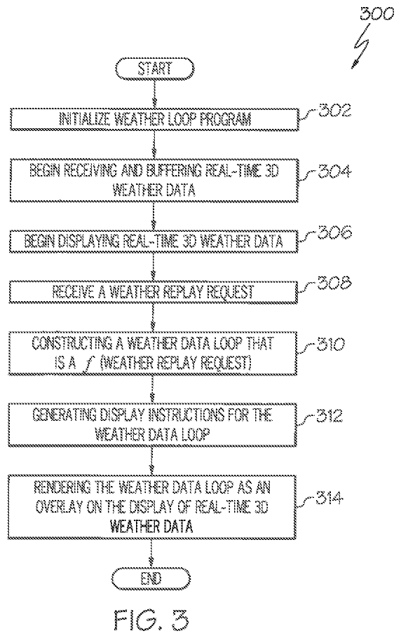

The 3D weather radar system 101 senses weather data within a predefined three-dimensional volume 105 in front of the aircraft 100. In some embodiments, the 3D weather radar system 101 senses weather data and terrain data within the volume 105 in front of the aircraft 100. In an embodiment, the predefined volume 105 is a conical shape that begins at the nose of the aircraft 100 and extends forward along an extension of the aircraft centerline 113, by a range 107. The conical shape is imparted on the volume 105 by splaying outward from the forward extension of the aircraft centerline 113 by an angle alpha 109 in all directions. Described differently, line 111 is drawn tangent to the nose of aircraft 100 and perpendicular to the aircraft centerline 113, therefore an angle 115 plus angle alpha 109 equals 90 degrees. In various embodiments, alpha 109 is 80 degrees, and angle 115 is 10 degrees. In various embodiments, the range 107 is 320 nautical miles. The subset 119 is described in connection with FIG. 3, below.

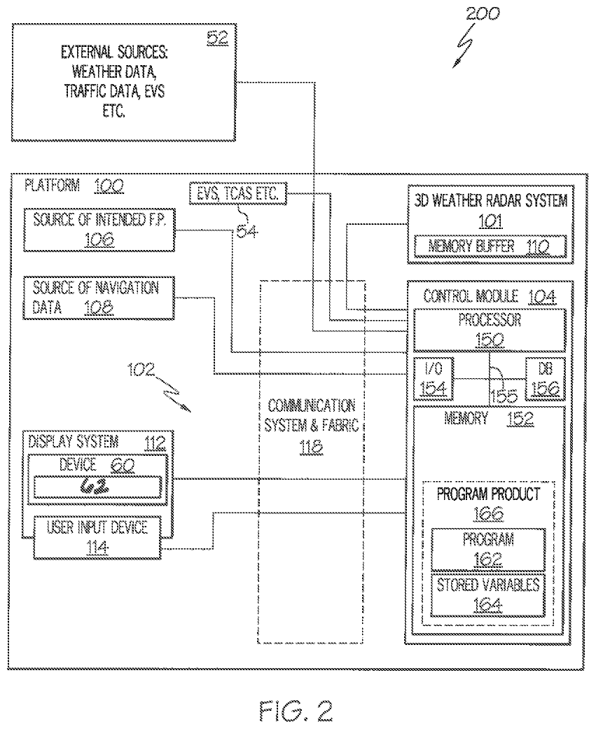

At a snapshot of time, t0, the real-time weather data for the 3D volume 105 constitutes a volumetric block of data that is time-stamped t0. Analyzing a weather trend or temporal context for weather requires that a pilot have access to at least some weather data from a timestamp t1 that is prior to t0O (i.e., t1 is before t0, t1<t0). As shown in FIG. 2, the memory buffer 110 is used to store the real-time 3D weather data, as time-stamped 3D weather data. The control module 104 (described in more detail below), may control the storage in the memory buffer 110 by, for each time t, associating the time stamp t with the volumetric block of data that is the real-time weather data for the 3D volume 105. In some embodiments, the memory buffer 110 is part of the on-board 3D weather radar system 101. In other embodiments, the memory buffer 110 is a portion of a memory 152 within the 3D weather display system 102.

The controlling component of the system 102 is the control module 104. In some embodiments, the control module 104 may be integrated within a preexisting mobile platform management system, avionics system, cockpit display system (CDS), flight controls system (FCS), or aircraft flight management system (FMS). Although the control module 104 is shown as an independent functional block, onboard the aircraft 100, in other embodiments, it may exist in an electronic flight bag (EFB) or portable electronic device (PED), such as a tablet, cellular phone, or the like. In embodiments in which the control module is within an EFB or a PED, a display system 112 and user input device 114 may also be part of the EFB or PED.

The control module 104 may be operationally coupled to any combination of the following aircraft systems: a source of an intended flight path 106, such as a navigation database (NavDB); a source of real-time aircraft navigation data 108, such as a navigation system; one or more external sources 52 of data, such as sources of 3D weather data, traffic data, EVS data, and/or other sensor data; and, a display system 112. In various embodiments, a communication system and fabric 118 may be employed to interface the aircraft systems. Additionally, the system 102 may include a user input device 114. The functions of these aircraft systems, and their interaction, are described in more detail below.

An intended flight path may include a series of intended geospatial midpoints between a departure and an arrival, as well as performance data associated with each of the geospatial midpoints (non-limiting examples of the performance data include intended navigation data, such as: intended airspeed, intended altitude, intended acceleration, intended flight path angle, and the like). As such, the intended flight path may be part of an operational flight plan (OFP). A source of the intended flight path 106 may be a storage location or a user input device. In various embodiments, a navigation database, NavDB, is the source of the active trajectory or OFP. The NavDB is generally a storage location that may also maintain a database of flight plans, and/or information regarding terrain and airports and/or other potential landing locations (or destinations) for the aircraft 100.

Real-time aircraft navigation data may include any of: an instantaneous location (e.g., the latitude, longitude, orientation), an instantaneous heading (i.e., the direction the aircraft is traveling in relative to some reference), a flight path angle, a vertical speed, a ground speed, an instantaneous altitude (or height above ground level), and a current phase of flight of the aircraft 100. As used herein, “real-time” is interchangeable with current and instantaneous. In some embodiments, the real-time aircraft navigation data is generated by a navigation system. The navigation system may be realized as including a global positioning system (GPS), inertial reference system (IRS), or a radio-based navigation system (e.g., VHF omni-directional radio range (VOR) or long-range aid to navigation (LORAN)), and may include one or more navigational radios or other sensors suitably configured to support operation of a flight management system (FMS), as will be appreciated in the art. In various embodiments, the data referred to herein as the real-time aircraft navigation data may be referred to as state data. The real-time aircraft navigation data is made available, generally by way of the communication system and fabric 118, so other components, such as the control module 104 and the display system 112, may further process and/or handle the aircraft state data.

External sources 52 provide real-time 3D weather data, 3D traffic data, EVS data, and other sensor data. In various embodiments, the external source 52 is another aircraft (traffic). In various embodiments, one or more external sources 52 include another aircraft, a ground station, a satellite, or another transmitting source. When a nearby traffic is equipped with the enhanced 3D weather display system 102, it may transmit to the aircraft 100, its own real-time and/or time-stamped three-dimensional weather data. In various embodiments, the external source 52 is a neighbor traffic and the data received from the external source includes real-time traffic data. Each individual occurrence of conventionally available traffic data is usually a snapshot of information about a specific traffic provided by at least one of: an Automatic Dependent Surveillance-Broadcast (ADS-B); a Traffic Information Services-Broadcast (TIS-B); an onboard Traffic Collision and Avoidance System (TCAS); a radio altitude sensor, inertial reference system (IRS); an altitude and heading reference system (AHRS); and, etc. Real-time traffic data generally provides the control module 104 with a snapshot of aircraft-specific traffic information for one or more traffic around an ownship at any given time. The real-time traffic information may include: an instantaneous position (e.g., the latitude, longitude, orientation), an instantaneous heading (i.e., the direction the traffic is traveling in relative to some reference), a flight path angle, a vertical speed, a ground speed, an instantaneous altitude (or height above ground level), an aircraft track, drift, flight path angle, a current phase of flight of the traffic, inertial side slip, etc. A plurality of neighbor traffic has an associated plurality of respective traffic data and or an associated plurality of 3D weather data.

In various embodiments, a communications system and fabric 118 is configured to support instantaneous (i.e., real time or current) communications between on-board systems (i.e., the source of the intended flight path 106, the source of aircraft navigation data 108, and the display system 112), the control module 104, and one or more external data source(s) 52. As a functional block, the communications system and fabric 118 represents one or more transmitters, receivers, and the supporting communications hardware and software required for components of the system 102 to communicate as described herein. In various embodiments, the communications system and fabric 118 may have additional communications not directly relied upon herein, such as bidirectional pilot-to-ATC (air traffic control) communications via a datalink; support for an automatic dependent surveillance broadcast system (ADS-B); a communication management function (CMF) uplink; a terminal wireless local area network (LAN) unit (TWLU); an instrument landing system (ILS); and, any other suitable radio communication system that supports communications between the aircraft 100 and the various external source(s). In various embodiments, the control module 104 and communications system and fabric 118 also support the herein referenced controller pilot data link communications (CPDLC), such as through an aircraft communication addressing and reporting system (ACARS) router; in various embodiments, this feature may be referred to as a communications management unit (CMU) or communications management function (CMF). In summary, the communications system and fabric 118 may allow the aircraft 100 and the control module 104 to receive information that would otherwise be unavailable to the pilot and/or co-pilot using only the onboard systems.

The user input device 114 and the control module 104 may be cooperatively configured to allow a user (e.g., a pilot, co-pilot, or crew member) to interact with display devices 60 in the display system 112 and/or other elements of the system 102. Depending on the embodiment, the user input device 114 may be realized as a cursor control device (CCD), keypad, touchpad, keyboard, mouse, touch panel (or touchscreen), joystick, knob, line select key, voice controller, gesture controller, or another suitable device adapted to receive input from a user. When the user input device 114 is configured as a touchpad or touchscreen, it may be integrated with the display system 112. As used herein, the user input device 114 may be used by a pilot to communicate with external sources, such as ATC, to modify or upload the program product 166, etc. In various embodiments, the display system 112 and user input device 114 are onboard the aircraft 100 and are also operationally coupled to the communication system and fabric 118. In some embodiments, the control module 104, user input device 114, and display system 112 are configured as a control display unit (CDU).

In various embodiments, the control module 104, alone, or as part of a central management computer (CMS) or a flight management system (FMS), draws upon data and information from the source of intended flight path 106 and source of aircraft navigation data 108 to provide real-time flight guidance for aircraft 100. The real time flight guidance may be provided to a user as images, text, symbols, or movies, on the display system 112, audible emissions from an audio system, or the like. The display system 112 may display, on a display device 60, the ownship and the environment surrounding the ownship, and additionally render relevant information thereon. For example, the control module 104 may compare an instantaneous position and heading of the aircraft 100 with the operational flight plan data for the aircraft 100 and generate display commands to render images showing these features and distinguishing them from each other. The control module 104 may further provide flight guidance responsive to associating a respective airport, its geographic location, runways (and their respective orientations and/or directions), instrument procedures (e.g., approach procedures, arrival routes and procedures, takeoff procedures, and the like), airspace restrictions, and/or other information or attributes associated with the respective airport (e.g., widths and/or weight limits of taxi paths, the type of surface of the runways or taxi path, and the like) with the instantaneous position and heading of the aircraft 100 and/or with the intended flight plan for the aircraft 100.

The control module 104 may be said to display various images and selectable options described herein. In practice, this may mean that the control module 104 generates display commands. The control module 104 may perform display processing methods and graphics processing methods to thereby generate display commands for the display system 112 to cause the display device 60 to render thereon the image 62. Display processing methods include various formatting techniques for visually distinguishing objects and routes from among other similar objects and routes. Graphics processing methods may include various types of computer-generated symbols, text, and graphic information representing, for example, pitch, heading, flight path, airspeed, altitude, runway information, waypoints, targets, obstacles, terrain, and required navigation performance (RNP) data in an integrated, multi-color or monochrome form.

The display system 112 is configured to continuously receive and process the display commands from the control module 104. Responsive to the display commands, the display system 112 renders image 62 comprising various pictorial images, symbolic indicators, alerts, graphical user interface elements, tables, menus, and buttons, as described herein. The display system 112 includes a display device 60. In some embodiments, weather and in-air traffic around an ownship is displayed in the ownship cockpit in a lateral view, such as, on a horizontal situation indicator (HIS) or interactive navigation (INAV) display found on a multi-function display (MFD), and/or in a perspective view on a synthetic vision system (SVS). In other embodiments, weather and in-air traffic around an ownship is displayed in the ownship cockpit in a vertical view, such as, on a vertical situation display (VSD). In still other embodiments, weather and in-air traffic around an ownship is concurrently displayed in a lateral view and a vertical view. In exemplary embodiments, the display device 60 is realized on one or more electronic display devices, such as a multi-function display (MFD) or a multi-function control display unit (MCDU), configured as any combination of: a head up display (HUD), an alphanumeric display, a vertical situation display (VSD) and a lateral navigation display (ND). Further, in various embodiments described herein, the display system 112 includes a synthetic vision system (SVS).

As used herein, the term “module” refers to any means for facilitating communications and/or interaction between the elements of the system 102 and performing additional processes, tasks and/or functions to support operation of the system 102, as described herein. Accordingly, in various other embodiments, the control module 104 may be any hardware, software, firmware, electronic control component, processing logic, and/or processor device, individually or in any combination, such as: a content addressable memory; a digital signal processor; an application specific integrated circuit (ASIC), a field programmable gate array (FPGA); any suitable programmable logic device; combinational logic circuit including discrete gates or transistor logic; discrete hardware components and memory devices; and/or any combination thereof, designed to perform the functions described herein.

In the embodiment shown in FIG. 2, the control module 104 is depicted as an enhanced computer system implemented or realized with a processor 150 and memory 152. The processor 150 is specifically programmed with the below described weather replay program 162, which it executes to perform the operations and functions attributed to the control module 104 and the system 102. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals. The memory 152 may comprise RAM memory, ROM memory, flash memory, registers, a hard disk, or another suitable non-transitory short or long-term storage media capable of storing computer-executable programming instructions or other data for execution. The memory 152 may be located on and/or co-located on the same computer chip as the processor 150. Generally, the memory 152 maintains data bits and may be utilized by the processor 150 as storage and/or a scratch pad during operation. Information in the memory 152, such as the weather replay program 162 may be organized and/or imported from an external source during an initialization step of a process; it may also be programmed with the weather replay program 162 via a user input device 114. In some embodiments, a database 156 is part of the memory 152. In various embodiments, the database 156 has airport features data and terrain features data stored within it.

The weather replay program 162 may be stored in the memory 152. Weather replay program 162 includes rules and instructions which, when executed by the processor, cause the control module to perform the functions, techniques, and processing tasks associated with the operation of the system 102. The weather replay program 162 and associated stored variables 164 may be stored in a functional form on computer readable media, for example, as depicted, in memory 152. While the depicted exemplary embodiment of the control module 104 is described in the context of a fully functioning computer system, those skilled in the art will recognize that the mechanisms of the present disclosure are capable of being distributed as a program product 166.

As a program product 166, one or more types of non-transitory computer-readable signal bearing media may be used to store and distribute the weather replay program 162, such as a non-transitory computer readable medium bearing the program 162 and containing therein additional computer instructions for causing a computer processor (such as the processor 150 in control module 104) to load and execute the weather replay program 162. Such a program product 166 may take a variety of forms, and the present disclosure applies equally regardless of the type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized as memory 152 and as program product time-based viewing of clearance requests in certain embodiments.

In various embodiments, the processor/memory unit of the control module 104 may be communicatively coupled (via a bus 155) to an input/output (I/O) interface 154, and a database 156. The bus 155 serves to transmit programs, data, status and other information or signals between the various components of the control module 104. The bus 155 can be any suitable physical or logical means of connecting computer systems and components. This includes, but is not limited to, direct hard-wired connections, fiber optics, infrared and wireless bus technologies.

The I/O interface 154 enables intra control module 104 communication, as well as communications between the control module 104 and other system 102 components, and between the control module 104 and the external data sources via the communication system and fabric 118. The I/O interface 154 may include one or more network interfaces and can be implemented using any suitable method and apparatus. In various embodiments, the I/O interface 154 is configured to support communication from an external system driver and/or another computer system. In one embodiment, the I/O interface 154 is integrated with the communication system and fabric 118 and obtains data from external data source(s) directly. Also, in various embodiments, the I/O interface 154 may support communication with technicians, and/or one or more storage interfaces for direct connection to storage apparatuses, such as the database 156.

Having described the functional blocks, we now move to the operation of the system 102. The 3D weather display system 102 introduces an optimal strategy for rendering a replay of (i) the total available 3D weather data, and/or (ii) a subset of the total available 3D weather data, as a simultaneously and continuously replaying overlay, on the display of the real-time 3D weather data.

In FIG. 3, a method 300 for enhanced 3D weather display is described. Many of the method steps are performed by the control module 104. In an embodiment, the control module 104 comprises a processor 150 and memory 152, therefore, many of the method steps may be described as being performed by the control module 104 and/or by the processor 150. The control module 104 is initialized at 302. Therefore, in an embodiment, at 302, the processor 150 is programmed with the program 162, and then begins executing the instructions embodied in the program 162 to perform the functions attributed to the control module 104. At 304, the processor 150 begins receiving real-time 3D weather data and storing time-stamped 3D weather data into the memory buffer 110. In various embodiments, the time stamps are continuous. As used herein, the collective time stamps stored in the memory buffer 110 at any given time are referred to as a span of time. As the time-stamped 3D weather data is sequentially captured and stored into the memory buffer 110, the memory buffer 110 can eventually fill up or the amount of collected data can become unreasonable, therefore the time span may be limited. In an embodiment, the span of time is two hours. In various embodiments, the time span keeps moving to begin with the current time and extend backward in time; therefore, oldest weather data is discarded, and most recent weather data is kept.

At 306, the processor 150 begins displaying the real-time 3D weather data on the display device 60. Although not the subject of the present invention, it is to be understood that the display of the real-time 3D weather data on the display device 60 may include the display of aspects of navigational information (such as that provided by the source of the intended flight plan 108 and the source of navigation data 108), which is responsive to the processor 150 receiving and processing navigational data for the aircraft 100; this is understood to be continuous. The display system 112 may utilize the ownship navigational data to render current views in images displayed on display device 60 based at least in part on the navigational data for the aircraft 100.

At operation 308, the processor 150 receives a weather replay request. In various embodiments, the processor 150 receives the weather replay request prescribed in real-time from a pilot or crew via a user input device 114. In other embodiments, at 308, the processor obtains or uploads from memory a weather replay request that was previously prescribed by a user. The weather replay request may take various forms, and the processor 150 is operable to receive each of the weather replay requests. In an embodiment, the weather replay request is for the 3D volume 105. In an embodiment, the weather replay request is a selected subset 119 of the 3D volume 105 or a selected time frame from among the time span. In another embodiment, the weather replay request is any of: a selected subset 119 of the 3D volume 105, a selected altitude, and a selected time frame from among the time span. In another embodiment, the processor 150 is capable or accepting a weather replay request that is any of: a selected subset 119 of the 3D volume 105, a selected altitude, a selected point of view, and a selected time frame from among the time span. In another embodiment, the processor 150 is operable to receive a pilot selection of a phase of flight or flight leg and constructs a subset volume surrounding the pilot selection for display.

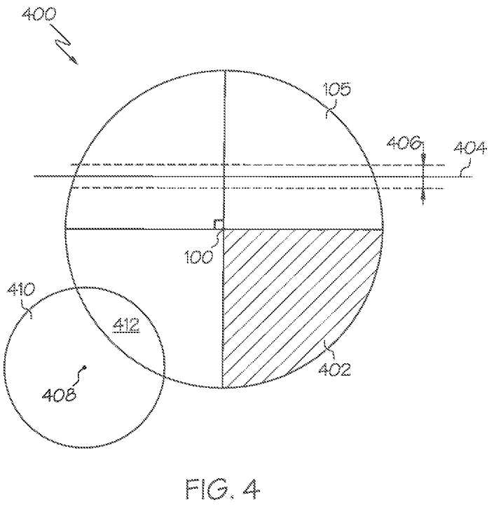

At 310, the processor 150 constructs a weather data loop that is a function of the weather replay request. As may be recognized, each of: the selected subset 119 of the 3D volume 105, the selected altitude, and the selected point of view are spatial requests. For spatial weather replay requests, to construct the weather data loop, the processor 150 identifies a spatial extent. If no duration of time is provided with the spatial extent, the processor 150 applies a preprogrammed duration of time. For example, in FIG. 4, a simplified two-dimensional view 400 is a forward-looking view from the nose of the aircraft 100 forward into the 3D volume 105 (it is understood that although the provided view 400 is in two-dimensions, it is referencing the 3D volume 105). If the weather replay request is for the quadrant 402, quadrant 402 is the spatial extent, and the processor 150 extracts time-stamped 3D weather data from the memory buffer 110 that matches the spatial extent, quadrant 402. In an embodiment, the user has also supplied a duration of time, so the processor 150 further limits the extracted time-stamped 3D weather data from the memory buffer 110 to the provided duration of time. If the weather replay request is an altitude 404, the processor 150 applies a preprogrammed margin 406 and the spatial extent is the band created by the altitude 404 within the margin 406. The duration of time procedure is the same as already described.

When the processor 150 receives a weather replay request that is only a duration of time, the processor applies a default spatial extent. In an embodiment, the default spatial extent is the entire 3D volume 105. The “point of view” is described in more detail below.

At 312 the processor 150 generates display instructions for the display device 60 to render the weather data loop, as a simultaneously and continuously replaying overlay, on the display of the real-time 3D weather data. At 314, the display device 60 responds to the display instructions by rendering the weather data loop, as a simultaneously and continuously replaying overlay, on the display of the real-time 3D weather data. The display instructions include instructions to display the real-time 3D weather data using a first visualization format; and render the weather data loop using a second visualization format that is different than the first visualization format. In an embodiment, the first format is the rainbow of colors, used to display the real-time 3D weather data and communicate weather intensity, and the second format is the same rainbow of colors, but with added texture, such as cross-hatching. In another embodiment, the first format is a grey scale, used to display the real-time 3D weather data and communicate weather intensity, and the second format is the same grey scale, but with added texture, such as dashed lines. A variety of other techniques may be used to distinguish the real-time 3D weather data from the replay weather data loop.

After 314 the method 300 may end or repeat.

As mentioned, the communications system and fabric 118 is communicatively coupled to the 3D display system and is for receiving real-time sensor data from external sources 52. In various embodiments, the data from external sources 52 may include 3D weather data and traffic data, 3D traffic data, enhanced vision system (EVS) data, and other sensor data. In various embodiments, the data from external sources 52 include 3D weather data, 3D traffic data, EVS data, and other sensor data. Additionally, and with reference again to FIG. 2, the communications system and fabric 118 is for receiving real-time sensor data from onboard sensor sources, such as, but not limited to, 3D weather radar system 101, and internal sensor sources 54, such as a source of traffic data, like TCAS, and an onboard enhanced vision system (EVS).

It is to be appreciated that, during operation, the processor 150 is continuously operable to receive data from one or more onboard sources, such as 3D weather radar system 101, and internal sources 54, such as EVS, TCAS, etc., and determine the point of view of the ownship aircraft 100 and generate the predefined three-dimensional volume (FIG. 1, 105) in front of the aircraft 100. In various embodiments, wherein the communications system 118 is further operable for receiving sensor data from on-board sources including: real-time 3D weather data, 3D traffic data, EVS sensor data and other sensor data, the processor 150 is further for determining the point of view of the external source (FIG. 4, 408) based on received sensor data from the one or more on-board sources.

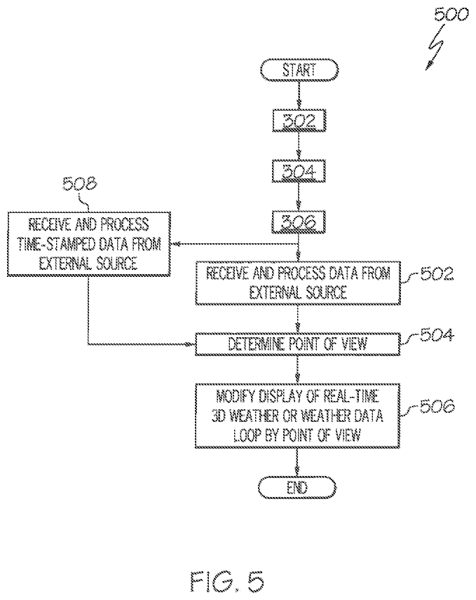

Turning now to FIG. 5 and with continued reference to FIGS. 1-4, in another exemplary method 500, after 302, 304 and 306 from the method 300, the processor 150 further: at 502, receives and processes the real-time 3D weather data and traffic data transmitted from an external source (FIG. 4, 408) to determine therefrom a point of view of the external source 408 (at 504). As shown in FIG. 4, external source 408 has its own 3D volume 410, of which some spatial overlap 412 with 3D volume 105 is present. In order to determine a point of view of the external source 408, the processor 150 uses the traffic data to determine a spatial relationship between the external source 408 and the aircraft 100 (e.g., external source is 1 nautical mile behind aircraft 100, and 10,000 feet below the altitude of aircraft 100). The spatial relationship enables the processor 150 to determine the point of view of the external source 408. In various embodiments, the external source 52 is another aircraft (aircraft 2). In various embodiments, the external source 52 is a ground station, satellite, cloud, or other transmitting source. At 506, the processor 150 may cause the display device 60 to integrate into the display of the real-time 3D weather, traffic, EVS, and sensor data the externally sourced real-time 3D weather, traffic, EVS, and sensor data modified by the point of view of the other aircraft or transmitting source. In various embodiments, at 506, the operation of causing the display device 60 to integrate into the display of the real-time 3D weather data the externally sourced real-time 3D weather data modified by the point of view of the other aircraft is contingent upon having received a point of view weather replay request.

In various embodiments, at 508, the processor 150 receives and processes time stamped 3D weather data and traffic data transmitted from the external source (FIG. 4, 408) and determines therefrom the point of view of the external source 408 (at 504). At 506, the processor 150 may cause the display device 60 to integrate into the weather data loop respective time-stamped 3D weather data from the external source 408. After 506, the method 500 may repeat or end. In various embodiments, at 502 and/or 508, the processor 150 receives, for each of a plurality of traffic, respective 3D weather data and/or time stamped 3D weather data.

As alluded to, traffic information is information about other aircraft in the vicinity of the aircraft 100, and the traffic information received from a neighbor traffic may comprise: a traffic identification, a position (latitudinal and longitudinal), orientation (roll, pitch), aircraft track, speed, altitude, distance from ownship, drift, flight path angle, a current phase of flight of the traffic, a heading, an inertial side slip, etc. In various embodiments, at 502 and/or 508, the processor 150 receives, for each of a plurality of traffic, respective traffic information.

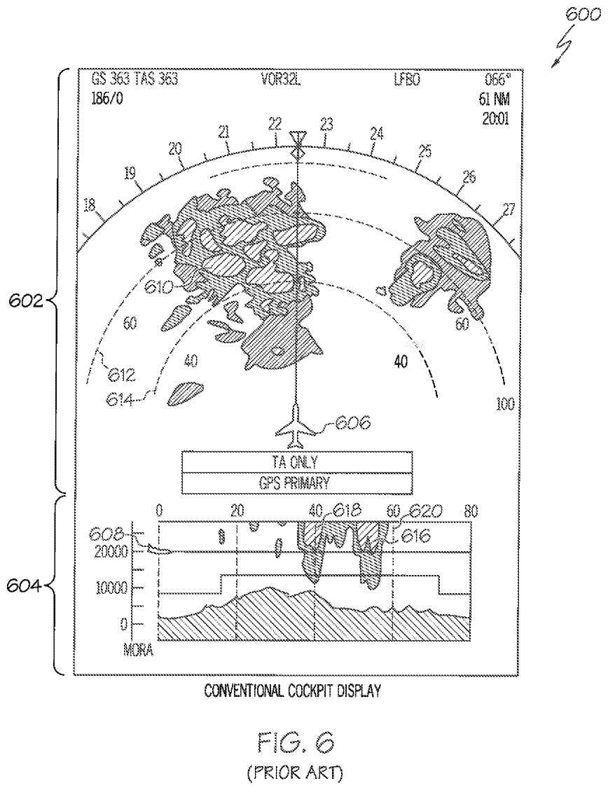

FIG. 6 depicts a conventional cockpit display 600, having an upper portion that is a lateral navigation display, also referred to as a horizontal navigation display 602, and a lower portion that is a vertical situation display 604. With respect to cockpit display 600, and as may be familiar to those with skill in the art: the aircraft 100 is demarked aircraft 606 on the horizontal navigation display 602, roughly the center bottom of the horizontal navigation display 602, and having multiple concentric distance/range arcs demarking nautical miles (NM) extending around the aircraft 606; and, the aircraft 100 is demarked aircraft 608 on a vertical altitude tape on the left in the vertical situation display (VSD) 604. The vertical speed tape extends from zero at the bottom to above 25,000 ft above sea level (the aircraft 608 is located at approximately 20000 ft. above sea level). Moving left to right horizontally in the VSD 604, distance/range ahead of the aircraft 608 is demarked in nautical miles. FIG. 6 is understood to depict a snapshot in time of a continuous rendering of real-time 3D weather. One weather event 610 is rendered on the horizontal navigation display 602 extending at least between 40 nautical miles (614) and 60 nautical miles (612) ahead of the aircraft 606, to the left of an extension of the aircraft 100 centerline. Weather event 610 corresponds to weather event 616 on the VSD 604, which is depicted at least between 40 nautical miles (618) and 60 nautical miles (620) ahead of aircraft 608.

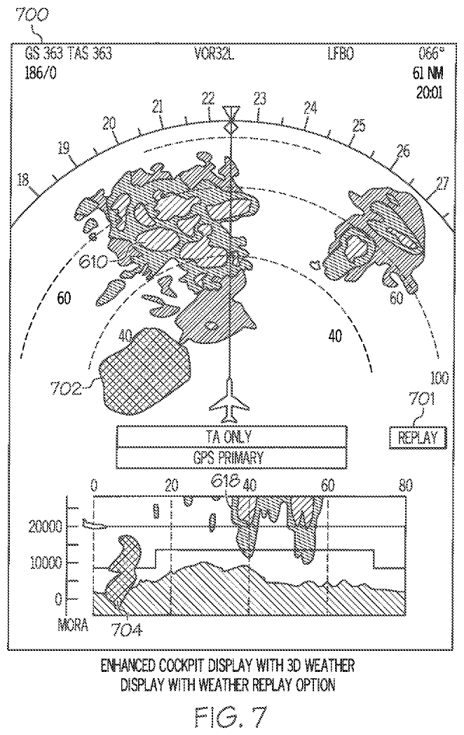

Turning now to FIG. 7, enhanced cockpit display 700 begins with the features of conventional cockpit display 600 and adds features that the 3D weather display system 102 introduces, such as selectable replay options. A replay indicator 701 is rendered on the enhanced cockpit display 700 to show a viewer that the replay option is in use. In FIG. 7, the replay indicator 701 is the word “replay” in a text box with a visually distinguishable boundary, however, multiple other replay indicators 701 may be employed. In the embodiment depicted in FIG. 6 and FIG. 7, the weather events 610 and 616 are rendered in first format. The first format in the example embodiment is a grey scale to visually distinguish intensity. In FIG. 7, a weather data loop that is a function of a user supplied weather replay request has been constructed by the processor 150, and the resulting weather data loop depicts a weather event 702 less than 40 nautical miles from the aircraft 606. The processor 150 renders the weather data loop using a second format that is different than the first format. In the exemplary embodiment, the second format is the grey scale of the first format, with added texture, specifically, cross-hatching, however, as stated, the first and second formats can vary, the only requirement is that they are distinguishably different from each other. The weather event 702 is also depicted in the VSD 604 as weather event 704. When data from other external sources 52, such as additional sensor data from traffic sensors, EVS sensors, or the like, is received and processed by the control module 104, additional formats may be used to distinguish each of them from each other.

Thus, technologically improved systems and methods for 3D weather display with replay options are provided.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate the interchangeability of hardware and software, various illustrative components, blocks, modules, circuits, and steps have been described above generally in terms of their functionality. Whether such functionality is implemented as hardware or software depends upon the application and design constraints imposed on the overall system.

Skilled artisans may implement the described functionality in varying ways for each application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

Further, the various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of the method or algorithm described in connection with the embodiments disclosed herein may be embodied directly in hardware, in a software module executed by a controller or processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. When “or” is used herein, it is the logical or mathematical or, also called the “inclusive or.” Accordingly, A or B is true for the three cases: A is true, B is true, and, A and B are true. In some cases, the exclusive “or” is constructed with “and;” for example, “one from A and B” is true for the two cases: A is true, and B is true.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft, comprising:
a three-dimensional (3D) weather radar system for sensing real-time 3D weather data within a 3D volume;
a memory buffer communicatively coupled to the 3D weather radar system, for storing the real-time 3D weather data, as time-stamped 3D weather data; and
a 3D weather display system communicatively coupled to the 3D weather radar system and the memory buffer, the 3D weather display system comprising:
a display device for displaying the real-time 3D weather data;
a user input system; and
a processor communicatively coupled to the display device and the user input system, the processor for:
receiving, from the 3D weather radar system, the real-time 3D weather data within a 3D volume;
instructing the display device to display the real-time 3D weather data;
receiving, from the user input system, a weather replay request;
constructing a weather data loop that is a function of the weather replay request, by extracting time-stamped 3D weather data from the memory buffer; and
generating display instructions to render the weather data loop, as a simultaneously and continuously replaying overlay, on the display of the real-time 3D weather data; and
the display device, responsive to the display instructions, renders the weather data loop, as a simultaneously and continuously replaying overlay, on the display of the real-time 3D weather data.

2. The aircraft of claim 1, wherein:
to construct the weather data loop, the processor identifies a spatial extent and a duration of time and extracts time-stamped 3D weather data from the memory buffer that matches the respective spatial extent and the respective duration of time.

3. The aircraft of claim 2, wherein:
a weather replay request is any of: a selected subset of the 3D volume, a selected time frame, a selected altitude, and a selected point of view.

4. The aircraft of claim 3, wherein the display device further:
displays the real-time 3D weather data using a first visualization format; and
renders the weather data loop using a second visualization format that is different than the first visualization format.

5. The aircraft of claim 4, further comprising:
a communications system communicatively coupled to the display system, the communications system for receiving from an external source, one or more of: real-time 3D weather data, 3D traffic data, EVS data or any other sensor data; and
wherein the processor is further for:
determining a point of view of the external source; and
generating instructions for the display device to integrate into the display of the real-time 3D weather data the received real-time 3D weather data from the external source, modified by the point of view of the external source;
wherein the communications system is further operable for receiving from an on-board source, one or more of: real-time 3D weather data, 3D traffic data, EVS sensor data and other sensor data; and
wherein the processor is further for:
determining the point of view of the external source based on received sensor data from the on-board source.

6. The aircraft of claim 5, wherein the processor is further for:
receiving time stamped data from the external source;
receiving time stamped data from the internal source; and
integrating the time stamped data from the external source and time stamped data from the internal source into the weather data loop.

7. A processor-implemented method for three-dimensional (3D) weather display, comprising:
receiving, from a 3D weather radar system, real-time 3D weather data within a 3D volume;
instructing a display device to display the real-time 3D weather data;
storing time-stamped 3D weather data into a memory buffer;
receiving, from a user input system, a weather replay request;
constructing a weather data loop that is a function of the weather replay request, by extracting time-stamped 3D weather data from the memory buffer; and
generating display instructions to render the weather data loop, as a simultaneously and continuously replaying overlay, on the display of the real-time 3D weather data; and
at a display device,
responsive to the display instructions, rendering the weather data loop, as a simultaneously and continuously replaying overlay, on the display of the real-time 3D weather data.

8. The method of claim 7, wherein:
constructing the weather data loop comprises identifying a spatial extent and a duration of time and extracting time-stamped 3D weather data from the memory buffer that matches the respective spatial extent and the respective duration of time.

9. The method of claim 8, wherein:
a weather replay request is any of: a selected subset of the 3D volume, a selected time frame, a selected altitude, and a selected point of view.

10. The method of claim 9, further comprising:
at the display device, displaying the real-time 3D weather data using a first visualization format; and p1 rendering the weather data loop using a second visualization format that is different than the first visualization format.

11. The method of claim 10, further comprising:
receiving from an external source, one or more of: real-time 3D weather data, 3D traffic data, EVS data; and
wherein the processor is further for:
determining a point of view of the external source; and
generating instructions for the display device to integrate into the display of the real-time 3D weather data the received real-time 3D weather data from the external source, modified by the point of view of the external source;
wherein the communications system is further operable for receiving from an on-board source, one or more of: real-time 3D weather data, 3D traffic data, EVS sensor data and other sensor data; and
wherein the processor is further for:
determining the point of view of the external source based on received sensor data from the on-board source.

12. The method of claim 11, further comprising:
receiving time stamped data from the external source;
receiving time stamped data from the internal source; and
integrating the time stamped data from the external source and time stamped data from the internal source into the weather data loop.

13. A three-dimensional (3D) weather display system, the 3D weather display system comprising:
a display device configured to render a horizontal navigation display and a vertical situation display;
a memory buffer;
a control module for receiving real-time 3D weather data within a predefined volume from a 3D weather radar system, generating display instructions for the display device to render the real-time 3D weather data, and storing the real-time 3D weather data in the memory buffer;
the control module receiving a weather replay request prescribed by a user and extracting time-stamped 3D weather data from the memory buffer to construct a weather data loop that is a function of the weather replay request; and
the control module generating display instructions to render the weather data loop, as a simultaneously and continuously replaying overlay, on the display of the real-time 3D weather data; and
the display device renders the weather data loop and the real-time 3D weather data in accordance with the display instructions.

14. The 3D weather display system of claim 13, wherein:
the control module constructs the weather data loop by identifying, from the weather replay request, a spatial extent and a duration of time, and extracting time-stamped 3D weather data from the memory buffer that matches the respective spatial extent and the respective duration of time.

15. The 3D weather display system of claim 14, wherein:
a weather replay request is any of: a selected subset of the 3D volume, a selected time frame, a selected altitude, and a selected point of view.

16. The 3D weather display system of claim 15, wherein the display device further:
displays the real-time 3D weather data using a first visualization format; and
renders the weather data loop using a second visualization format that is different than the first visualization format.

17. The 3D weather display system of claim 16, further comprising the control module:
receiving from an external source, one or more of: real-time 3D weather data, 3D traffic data, EVS data; and
wherein the processor is further for:
determining a point of view of the external source; and
generating instructions for the display device to integrate into the display of the real-time 3D weather data the received real-time 3D weather data from the external source, modified by the point of view of the external source.

18. The 3D weather display system of claim 17, further comprising:
The control module receiving from the external source, time stamped data, and integrating into the weather data loop respective time-stamped data received from the external source.

19. The 3D weather display system of claim 17, wherein the external source is one of a plurality of external sources, and, for each external source of the plurality of external sources, the control module:
determines a point of view of the external source and generates instructions for the display device to integrate into the display of the real-time 3D weather data the received real-time 3D weather data from the external source, modified by the point of view of the external source.

20. The 3D weather display system of claim 17, wherein
the communications system is further operable for receiving from an on-board source, one or more of: real-time 3D weather data, 3D traffic data, EVS sensor data and other sensor data; and
wherein the processor is further for:
determining the point of view of the external source based on received sensor data from the on-board source.
